(19) United States
(12) Patent Application Publication
(10) Pub. No.: US 2002/0194091 A1
(43) Pub. Date: Dec. 19, 2002

(54) Method and virtual support system for providing semiconductor components and standalone simulators tagged to an individual component

(76) Inventors: Ilia Zverev, Munchen (DE); Anton Riedlhammer, Munchen (DE); Jurgen Petzoldt, Ilmenau (DE); Tobias Reimann, Ilmenau (DE)

Correspondence Address: LERNER AND GREENBERG, P.A., Post Office Box 2480, Hollywood, FL, 33022-2480, US

(21) Appl. No.: 09/867,642

(22) Filed: May 30, 2001

(51) Int. Cl. G06F 17/60

(52) U.S. Cl. 705/27

(57) ABSTRACT

Electronic components such as semiconductor chips are supported by the manufacturer by providing product developers an online catalogue with the electronic components that are available from the manufacturer. The novel support system links standalone simulators which allow circuit simulations with specific ones of the electronic components. These standalone simulators can be downloaded, installed, and executed by the product developer.

### BACKGROUND OF THE INVENTION

### Field of the Invention

The invention lies in the fields of circuit design and development and relates, more specifically, to a novel system of providing circuit components together with standalone simulators for the design integration of the circuit components. The invention also relates to a business model which aids in shortening and simplifying design cycles for high-tech component integration.

Modern business models concerning innovations and product development often include as one of the primary parameters so-called “time to market” considerations. This is particularly true in the fast-developing and highly competitive electronics field. New developments in the high-tech area are subject to substantial design and development costs, which typically include constructing and testing a prototype.

With the onset of widely available computing power, it has become possible to integrate simulations into the design cycle and simulations and simulators are now widely used to shorten certain design cycles and, with dependable and carefully constructed simulations, it is possible to predict the behavior of a given component product in its planned environment. It has thus become possible to partially optimize the system prior to the construction of the typically expensive and labor-intensive prototype. As a result, simulations have had a considerable impact in reducing research and development costs. Simulations are performed based on simulation models.

Simulation models and simulators are particularly important in the context of semiconductor components. Several semiconductor manufacturers now provide simulation models together with their corresponding semiconductor components. The simulation models for the specific components are developed in-house by the semiconductor manufacturer and then distributed to the customer via the Internet. This system is currently limited simulation models.

The customer is required to obtain the applicable simulation program which corresponds to the simulation model. Examples of widely distributed simulation programs include Pspice, SABER, and MicroCAP, to name a few. These are pricey programs that cost several ten thousand dollars.

After downloading the simulation model for a given semiconductor chip, the customer must then build the test circuit in the simulator. This requires a considerable amount of simulation know-how and is subject to considerable efforts. For example, the customer must learn the simulation program, they must understand the model or models of the components, and they must understand and insert any applicable parasitic elements. It is further disadvantageous that the commercially available simulators are designed with relative broad applicability and they are only marginally optimized for any given specific task, such as for power electronics. The consequence is long simulation periods with substantial loading of the applicable computing power, as well as numerical instability due to convergence problems.

All of these disadvantages lead to longer design cycles, delays in the time-to-market cycles, and increased R&D costs.

A further state-of-the-art alternative is the so-called on-line simulator. By way of example, an Internet simulator is provided by Transim Corp. (see http://www.transim.com). There, a simulator is provided which can be accessed via the Internet and which provides for the on-line simulation of predefined components and simulation circuits. In order to use the service, the customer accesses the corresponding web site, selects a given component from the menu, and starts a simulation. The results are provided directly to and displayed on the web browser.

In order for the customer to be able to use the service, they must be permanently connected to the Internet during the entire simulation process.

### SUMMARY OF THE INVENTION

It is accordingly an object of the invention to provide a method of providing simulation support and for tagging a simulation program to a given circuit component, which overcomes the above-mentioned disadvantages of the heretofore-known devices and methods of this general type and which provides for a standalone simulator that is specifically developed for a given circuit component and which can be utilized in standalone fashion without a permanent connection to the Internet.

With the foregoing and other objects in view there is provided, in accordance with the invention, a method of supporting an electronic component, such as a semiconductor chip, which comprises:

providing an online catalogue with electronic components;

storing a computer-executable file with a simulator for simulating a circuit behavior of a specific one of the electronic components;

linking the computer-executable file to the specific electronic component in the online catalogue and enabling download of the computer-executable file to a consumer and enabling the consumer to execute a simulation with the specific electronic component.

In accordance with an added feature of the invention, the manufacturer archives the computer-executable file and the system prompts the consumer to extract and install the computer-executable file prior to executing the simulation. In the alternative, the computer-executable file is a self-extract and/or self-install file.

In accordance with an additional feature of the invention, simulation models for the electronic components are also stored in the online catalogue and the consumer is enabled to download either a simulation model or a standalone simulator linked to a given one of the electronic components.

With the above and other objects in view there is also provided, in accordance with the invention, a virtual product support system, comprising:

a computer-readable file with a listing of electronic components available from the manufacturer;

a storage system storing computer-executable files with standalone simulators for simulating an electronic behavior of the electronic components;

a computer-readable file with a listing of the standalone simulators available in the storage system and with linking information between individual standalone simulators and individual electronic components; and

a network connection for providing access to the listing of standalone simulators and for enabling download, by a customer, of individual simulators via the network connection.

In accordance with a concomitant feature of the invention, the network connection is an Internet connection and the listing of the standalone simulators is hyperlinked to the computer-executable files.

Other features which are considered as characteristic for the invention are set forth in the appended claims.

Although the invention is illustrated and described herein as embodied in a standalone simulator and a method of tagging a standalone simulator to a given circuit component, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a block diagram providing an overview of the novel system in which a standalone simulator is accessible over the Internet; and

FIG. 2 is a diagrammatic view of a screen displaying a product support-related web page provided by a semiconductor manufacturer and a related download by a product developer of a standalone simulator.

### DESCRIPTION OF THE PREFERRED EMBODIMENTS

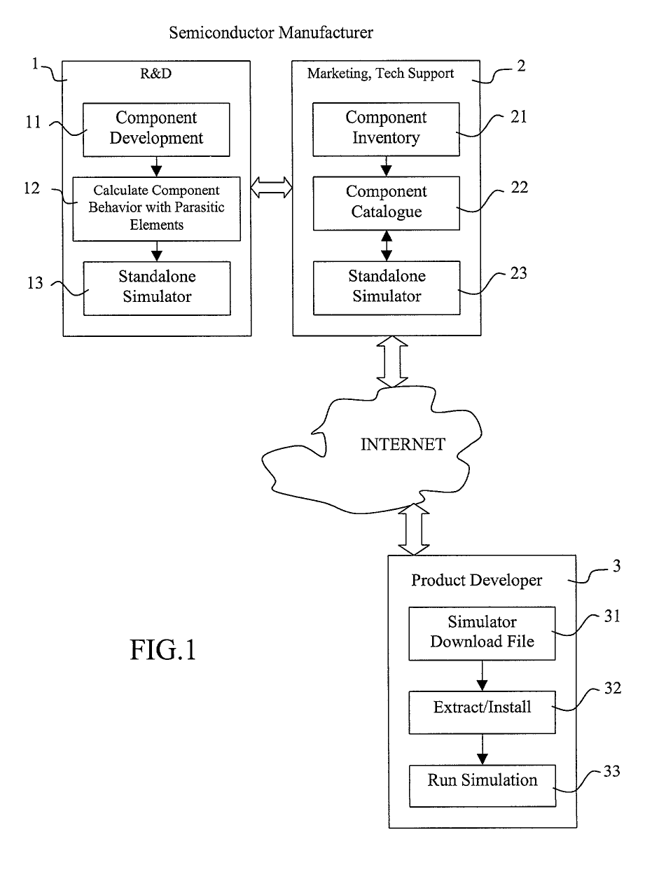

Referring now to the figures of the drawing in detail and first, particularly, to FIG. 1 thereof, there is seen a block 1 representing the research and development division of a component manufacturer and a block 2 representing the marketing, distribution, and technical support division of the same manufacturer.

Research and development R&D, in this context, deals with the development of new components, such as semiconductor chips, which can then be made available for sale through the marketing division 2. The researchers and technicians in charge of the development of the components at 11 are naturally also best equipped to calculate and predict the component behavior in applied circuits (see box 12 ). This specific know-how, in accordance with the invention, is integrated into a simulator at 13 which is specifically directed to a given semiconductor chip. Preparing such a standalone simulator is quite labor intensive (approximately one-half to a full programmer year). On the other hand, it is considered a relatively straight-forward and simple task to those of skill in the art. Accordingly, the specifics of writing the standalone simulator need not be described in detail herein.

The standalone simulator is then listed together with the corresponding component on the externally accessible product marketing page. For example, the customer—or potential customer—accesses the semiconductor manufacturer's web page through the Internet. There, a component catalogue 22 lists the components which are available in inventory 21. The individual components in the component catalogue 22 are hyperlinked to the individual standalone simulators which is available in a simulator directory 23, which is also accessible as an FTP (file transfer protocol) download site. The standalone simulators that are stored in the directory 23 are preferably packaged in archived and compressed format, thus taking up only approximately 1 to 2 MB of space. The completely packaged downloadable simulator file, including the extractable setup files and executable files, can thus be downloaded very quickly. This, of course, is a substantial advantage over the general purpose simulators which take up considerably more space.

The customer 3, that is a current or potential customer such as a product developer who is interested in a given semiconductor component from the component catalogue, selects and downloads the corresponding standalone simulator from the directory 23. The standalone simulator contains the selected components and their combinations, inclusive of the simulation circuit with the parasitic elements of the environment. Then, the archived file downloaded into the customer's computer 31 is extracted and installed at 32. At that point, the customer is ready to run the simulation 33 which is directly geared to the given component and which incorporates the most accurate predictions within the proposed product environment, as well as the discrete components and the expected parasitic behavior.

The parasitic elements have a most essential impact on the success of the simulation. Disregarding parasitic elements or miscalculations concerning parasitic behavior often leads to unacceptable differences between simulations and actual measurements. Here, in accordance with the invention, the simulator has been implemented by experts and it has been adapted to typically application boundaries. The customer thus does not have to build a test circuit and measure the same through a battery of tests.

The simulation can be started immediately upon download and installation. The simulation is started with default values and the simulator advantageously offers the user to enter simulation parameters either before running the simulation or even during the simulation.

Since the standalone simulator is optimized for the specific purpose, the simulation can run very quickly and with increased numeric stability.

The following table provides for a comparison of the novel approach according to the invention with the two above-described prior art systems:

| | General purpose simulator | On-line Internet | Standalone |
|---|---|---|---|
| Step | with simulation model | simulator | simulator |
| 1 | Acquire simulation | Access Internet | Download |
| | program | page with | standalone |
| | | simulation | simulator from |
| | | program | manufacturer's |
| | | | web page |
| 2 | Install simulation | Sign up for | Install |
| | program | access, sign on | standalone |
| | | to online session | simulator |
| 3 | Learn to operate | Online simulation | Standalone |
| | simulation program | | simulation |
| 4 | Download simulation model | | |
| | from component | | |
| | manufacturer's web page | | |
| 5 | Integrate simulation | | |
| | models into simulator | | |
| 6 | Program/configure | | |
| | simulation circuit in | | |
| | simulator | | |
| 7 | Standalone simulation | | |

The novel method of providing a standalone simulator that is specifically designed for and tagged to a specific component provides for a variety of advantages. These include:

The simulator is optimized for a specific purpose;

the simulation models of components are optimized for the simulator;

the customer need not construct and configure the circuit, since that task has been expeditiously performed by the experts;

no general purpose simulator is required, which is a substantial savings in preliminary expense;

no Internet access is required during the simulation;

the customer is not required to gain expertise concerning simulators; and

considerable reduction of the design cycle and time-to-market for a product.

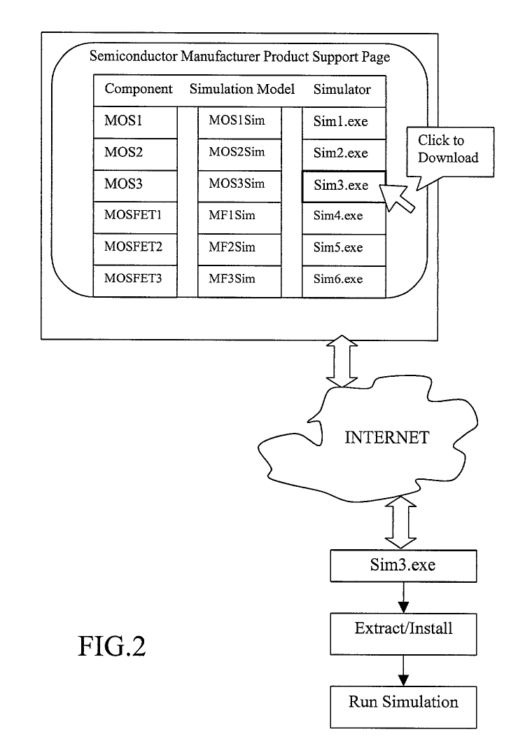

With reference to FIG. 2, an exemplary product support page may include a display with a listing of the product catalogue provided by the manufacturer. The individual products—here various MOS chips and MOSFET chips—are linked to simulation models (for those customers that wish to continue using their general purpose simulation programs) and to standalone simulators. The icons are hyperlinked so that the download of a corresponding program can be initiated by clicking. In the exemplary illustration, the customer is interested in the chip MOS3 and he downloads the corresponding program Sim3. After installing the simulator program, the product developer is ready to run the simulation, either with the default values or with realtime-variable parameters.

We claim

1. A method of supporting an electronic component, which comprises:
providing an online catalogue with electronic components;
storing a computer-executable file with a simulator for simulating a circuit behavior of a specific one of the electronic components;
linking the computer-executable file to the specific electronic component in the online catalogue and enabling download of the computer-executable file to a consumer and enabling the consumer to execute a simulation with the specific electronic component.

2. The method according to claim 1, wherein the storing step comprises archiving the computer-executable file and prompting the consumer to extract and install the computer-executable file prior to executing the simulation.

3. The method according to claim 1, which further comprises storing simulation models for the electronic components in the online catalogue and enabling the consumer to download either a simulation model or a standalone simulator linked to a given one of the electronic components.

4. A virtual product support system, comprising:
a computer-readable file with a listing of electronic components;
a storage system storing computer-executable files with standalone simulators for simulating an electronic behavior of the electronic components;
a computer-readable file with a listing of the standalone simulators available in said storage system and with linking information between individual standalone simulators and individual electronic components; and
a network connection for providing access to said listing of standalone simulators and for enabling download, by a customer, of individual simulators via said network connection.

5. The virtual product support system according to claim 4, wherein said network connection is an Internet connection and said listing of the standalone simulators is hyperlinked to said computer-executable files.
